(19) United States
(12) Patent Application Publication
(10) Pub. No.: US 2010/0080527 A1
(43) Pub. Date: Apr. 1, 2010

(54) PLAYBACK CONTROL APPARATUS AND PLAYBACK CONTROL METHOD

(75) Inventor: Takuya KONTANI, Inagi-shi (JP)

Correspondence Address: PATTERSON & SHERIDAN, L.L.P., 3040 POST OAK BOULEVARD, SUITE 1500, HOUSTON, TX, 77056, US

(73) Assignee: KABUSHIKI KAISHA TOSHIBA, Tokyo (JP)

(21) Appl. No.: 12/483,094

(22) Filed: Jun. 11, 2009

(30) Foreign Application Priority Data
Sep. 30, 2008 (JP) 2008-255201

(51) Int. Cl. H04N 5/91

(52) U.S. Cl. 386/46; 386/E05.003

(57) ABSTRACT

According to one embodiment, a playback control apparatus includes a setting module configured to set maximum playback time of a program depending on a genre, a designation module configured to designate a program, a detection module configured to detect a playback time depending on a genre of the designated program, and a playback control module configured to control playback of the designated program based on the maximum playback time.

### CROSS-REFERENCE TO RELATED APPLICATIONS

This application is based upon and claims the benefit of priority from Japanese Patent Application No. 2008-255201, filed Sep. 30, 2008, the entire contents of which are incorporated herein by reference.

### BACKGROUND

1. Field

One embodiment of the invention relates to a playback control apparatus and playback control method, which control playback based on the genres of programs.

2. Description of the Related Art

In recent years, upon improvement of viewing environments, viewable programs are increasing, and users can enjoy a variety of programs. Given such an increase in viewable programs, Jpn. Pat. Appln. KOKAI Publication No. 2007-282042 (reference 1) discloses a technique which relates to a program recommendation apparatus that recommends programs according to a user's preferences. According to this disclosed technique, the program recommendation apparatus registers user's preferences, searches program information for programs corresponding to the user's preferences, and provides a recommended program list based on the programs found.

Jpn. Pat. Appln. KOKAI Publication No. 2004-214966 (reference 2) discloses a technique which relates to a broadcast receiving apparatus which controls operations depending on users. According to this disclosed technique, the broadcast receiving apparatus authenticates a user, displays a recorded content list of the authenticated user, and plays back or edits selected recorded content.

Given the aforementioned increase in viewable programs, for example, parents are demanding control over program viewing depending on the genres of programs in accordance with the ages, genders, personalities, abilities, and the like of children. For example, assume that a parent schedules a child's program viewing as follows to foster the child's ability.

Language program: 10 hours/month

Music program: 5 hours/month

History program: 3 hours/month

In order to achieve the above viewing schedule, the parent designates programs of target genres and manages program viewing by, e.g., supervising the child. In addition, in order to prevent the viewing tendency from being biased, the parent has to manage viewing time depending on genres, thus imposing a heavy load on the parent.

The program recommendation apparatus disclosed in reference 1 above can recommend programs according to the user's preferences, but it cannot control viewing by the user (for example, a child) according to the genres of programs. That is, this program recommendation apparatus merely recommends programs that fit the registered user's preferences, but it cannot control viewing by the user in a balanced manner depending on the genres of programs in consideration of the viewing records of programs.

The broadcast receiving apparatus disclosed in reference 2 above can authenticate the user and can control playback or editing of content depending on the user, but it cannot control viewing by the authenticated user according to the genres of programs. That is, this broadcast receiving apparatus cannot control viewing by the user in a balanced manner depending on the genres of programs in consideration of the viewing records of programs.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a schematic block diagram showing the arrangement of a viewing scheduling television (playback control apparatus) according to an embodiment of the invention;

FIG. 2 is a flowchart showing program playback control according to the embodiment;

FIG. 3 is a flowchart showing viewing schedule setting processing according to the embodiment;

FIG. 4 is a table showing management of personal feature data according to the embodiment;

FIG. 5 is a table showing personal information according to the embodiment;

FIG. 6 is a table showing program information according to the embodiment;

FIG. 7 is a view showing a viewing schedule setting screen according to the embodiment;

FIG. 8A is a view showing a viewing schedule screen (initial screen) according to the embodiment;

FIG. 8B is a view showing a viewing schedule screen (a screen after the beginning of viewing) according to the embodiment; and

FIG. 9 is view showing a display screen of an unviewable message and a viewable list according to the embodiment.

### DETAILED DESCRIPTION

Various embodiments according to the invention will be described hereinafter with reference to the accompanying drawings. In general, a playback control apparatus according to one embodiment of the invention comprises: a setting module configured to set maximum playback time of a program depending on a genre; a designation module configured to designate a program; a detection module configured to detect a playback time depending on the genre of the designated program; and a playback control module configured to control playback of the designated program based on the maximum playback time.

An embodiment of the invention will be described hereinafter with reference to the drawings.

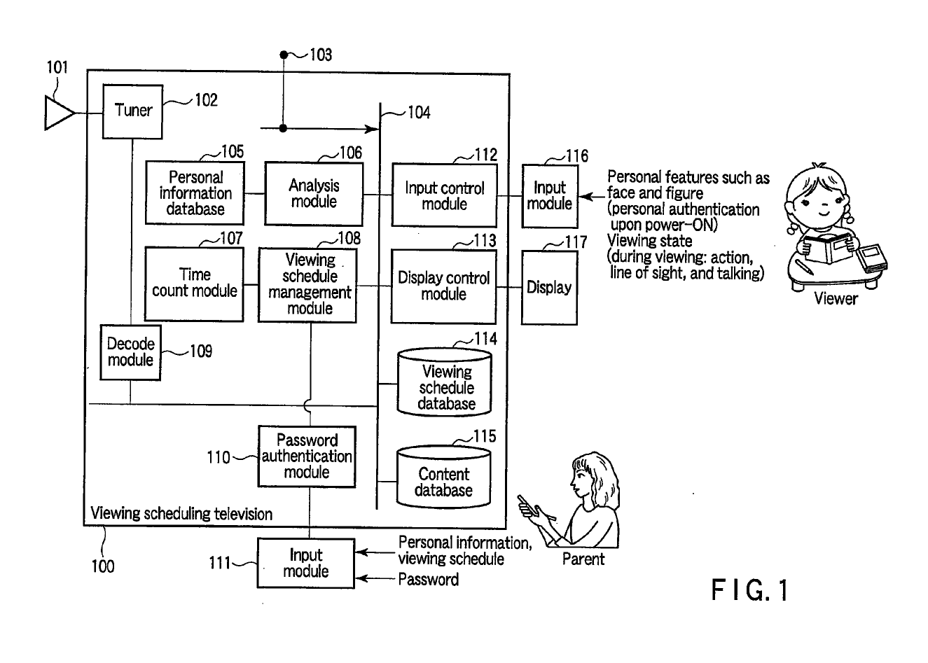

FIG. 1 is a schematic block diagram showing the arrangement of a viewing scheduling television (playback control apparatus) according to an embodiment of the invention. For example, a viewing scheduling television 100 can be equipped in homes with children. Nowadays, because of an increase in the number of channels (terrestrial, satellite, and cable), an increase in recordable capacity due to an increase in volume of storage media such as HDDs, and popularization of media such as DVDs, viewable content is exponentially increasing. Such a large amount of content includes content unsuitable for children. It is not desirable to unconditionally provide such a large amount of content to children with insufficient self-control. Parents want to provide a viewing schedule by checking content suited to children based on a broadcast program table or recorded content. However, it is troublesome for parents to make a viewing schedule of content, and it is difficult for parents to manage viewing of content and the like by supervising children.

The viewing scheduling television 100 to be described in this embodiment can solve the aforementioned problems. As shown in FIG. 1, the viewing scheduling television 100 includes a receiving antenna 101, tuner 102, input terminal 103, bus 104, personal information database 105, analysis module 106, time count module 107, viewing schedule management module 108, decode module 109, password authentication module 110, input module 111, information processing module 112, display control module 113, viewing schedule database 114, content database 115, input module 116, and display 117.

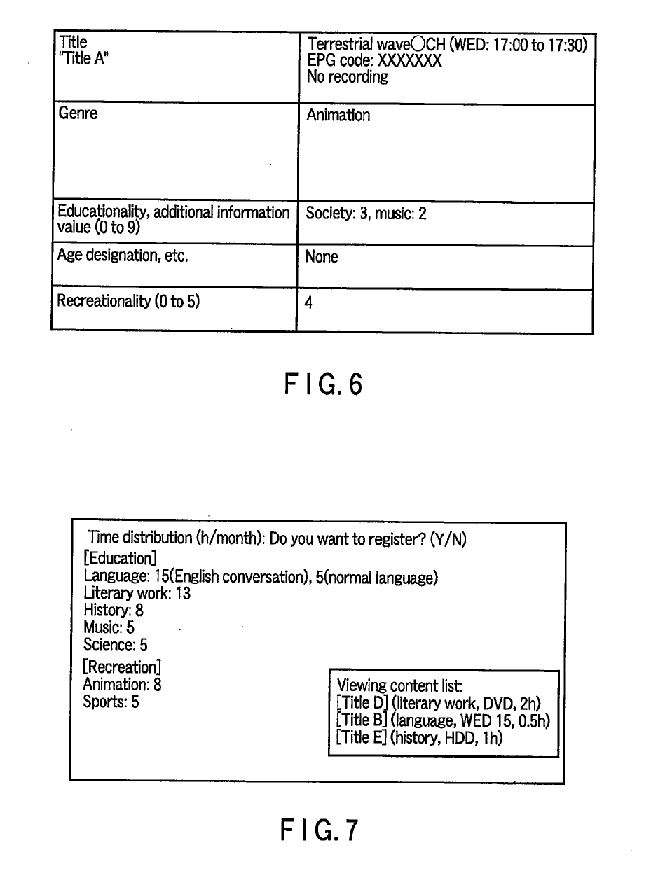

The receiving antenna 101 receives terrestrial and satellite broadcasts. The tuner 102 selects a signal of a designated channel from the received broadcast signal. The decode module 109 decodes the selected signal. For example, the received broadcast signal includes an electronic program guide (EPG), and the viewing schedule management module 108 generates program information shown in FIG. 6 based on the EPG. The generated program information is stored (registered) in the content database 115. The program information includes information such as a program title, genre, educationality, additional information value, age designation, and recreationality. For example, the additional information value is rated in 10 levels from 0 to 9 (society=3, music=2, etc.), and the recreationality is rated in six levels from 0 to 5.

The input terminal 103 inputs a signal from, for example, an HDD recorder or DVD player. The signal input from the input terminal 103 includes content data and content guide information, and the viewing schedule management module 108 generates the aforementioned program information based on this content guide information. The generated program information is stored (registered) in the content database 115.

The viewing schedule management module 108 can detect the genres of respective programs provided by broadcast signals received by the receiving antenna 101 and those of content provided by input signals input from the input terminal 103 based on the program information stored in the content database 115.

The input module 111 is, for example, an operation input unit, and accepts a power-on operation of the viewing scheduling television 100, a program designation operation, and the like. The input module 111 also accepts information inputs such as a password, personal information, and viewing schedule.

For example, a viewing scheduler (for example, a parent) can input personal information shown in FIG. 5 via the input module 111. That is, a viewer number is assigned to personal information, which includes information such as a name, gender, age, visual acuity, hearing acuity, personality/characteristic, hypersensitivity to stimuli and the like, abilities to be fostered (program viewing requests depending on the genres), and preferences of the person (program viewing requests depending on the genres). For example, the personality/characteristic can rate an affectivity, reasoning, sociability, anaclisis, behavioral property, and the like in 10 levels from 0 to 9. The abilities to be fostered can rate a language, science, literature, music, sports, history, and the like in six levels from 0 to 5. The preferences of the person can rate an animation, sports, entertainment, and the like in six levels from 0 to 5. The personal information is stored (registered) in the personal information database 105.

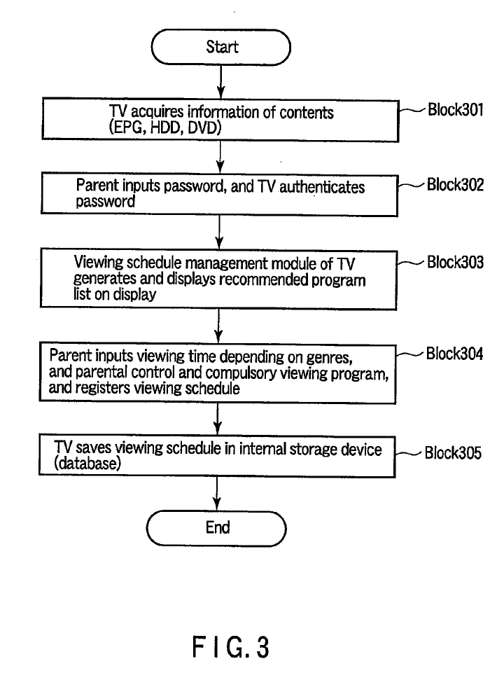

Furthermore, the viewing scheduler can set a viewing schedule for each viewer via the input module 111. FIG. 3 is a flowchart showing an example of viewing schedule setting processing.

As described above, the viewing scheduling television 100 (viewing schedule management module 108) acquires program information based on an EPG included in a received broadcast signal received via the antenna 101, and content guide information included in an input signal input from the input terminal 103 (BLOCK 301).

The viewing scheduler inputs a password via the input module 111. If the password authentication module 110 authenticates the input password (BLOCK 302), the viewing schedule management module 108 allows the viewing scheduler to set a viewing schedule.

If the viewing scheduler designates a viewing schedule setting mode and designates predetermined personal information of a plurality of items of personal information stored in the personal information database 105 via the input module 111, the viewing schedule management module 108 generates a recommended viewing list based on the program information stored in the content database 115 and the designated predetermined personal information, and the display 117 displays the generated recommended viewing list (BLOCK 303).

FIG. 7 is a view showing an example of a viewing schedule setting screen, which includes a recommended viewing list (recommended program list). For example, when the abilities to be fostered (program viewing requests depending on the genres) included in the personal information indicate “language”, “literature”, and “history”, the recommended viewing list includes programs associated with “language”, “literature”, and “history”. Furthermore, when priority levels are assigned in the order of “literature”, “language”, and “history” in the personal information, the recommended viewing list indicates viewing candidates in the order of “literature”, “language”, and “history”. For example, when a viewing request value for “literature” is highest, that for “language” is next highest, and that for “history” is low, the priority levels decrease in the order of “literature”, “language”, and “history”, and the recommended viewing list indicates viewing candidates in the order of “literature”, “language”, and “history”.

The viewing scheduler can set the viewing schedule via the input module 111 while observing the viewing schedule setting screen (BLOCK 304). That is, the viewing scheduler can set maximum viewing time depending on genres (maximum playback time depending on genres) per predetermined period (for example, per month). For example, the viewing scheduler can set the maximum viewing time (15 hours) of “language” (English conversation), the maximum viewing time (13 hours) of “literature”, the maximum viewing time (8 hours) of “history”, the maximum viewing time (5 hours) of “music”, the maximum viewing time (5 hours) of “science”, the maximum viewing time (8 hours) of “animation”, and the maximum viewing time (10 hours) of “sports”. Furthermore, the viewing scheduler can also set parental control. With the parental control, the viewing scheduler can designate a program name that he or she does not want to make the viewer (for example, a child) view, and an age limit of the viewer. Moreover, the viewing scheduler can set compulsory viewing programs.

The set viewing schedule is stored (registered) in the viewing schedule database 114 (BLOCK 305). The viewing schedule is assigned the same viewer number as that assigned to the personal information used in generation of the viewing schedule. That is, the personal information and viewing schedule are managed in association with each other based on the viewer number. That is, when a plurality of items of personal information are registered, and a plurality of viewing schedules are registered based on the respective items of personal information, the respective items of personal information and the viewing schedules are managed in association with each other.

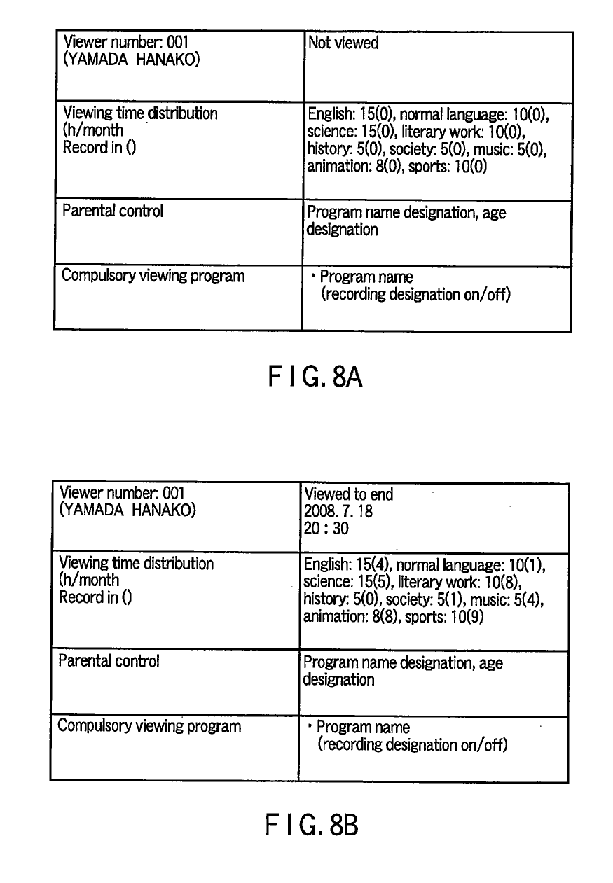

The display control module 113 can display the viewing schedule on the display 117. FIG. 8A is a view showing an example of a viewing schedule screen (initial screen) displayed on the display 117. As shown in FIG. 8A, the viewing schedule screen (initial screen) shows viewing time distributions depending on the genres (maximum playback time depending on the genre), and also viewing records depending on the genres. Note that the viewing schedule screen (initial screen) shown in FIG. 8 is that when the viewer has not viewed any program yet, and the viewing records indicate zero.

Note that the set viewing schedule can be changed halfway through. For example, although the maximum viewing time of “English” is set to be 15 hours initially, when viewing of “English” has progressed more than expected, and the viewing scheduler wants to permit more viewing of “English”, he or she can change the maximum viewing time of “English” to be 18 hours or the like via the input module 111. In this way, flexible responses can be made in accordance with the progress of viewings depending on the genres.

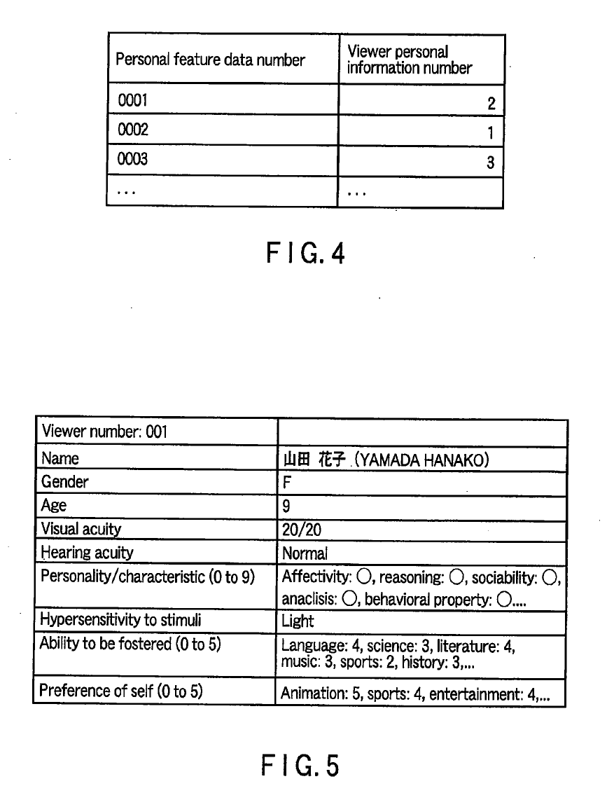

Viewer authentication will be described below. The input module 116 is, for example, a camera that captures an image of the viewer (e.g., the viewer's face) and a microphone that inputs the viewer's conversation, and the input control module 112 controls the input module 116. For example, when a viewer registration mode is executed via the input module 111, and the input module 116 captures an image of the viewer, the analysis module 106 analyzes a video captured by the input module 116 to acquire feature information of the viewer, and generates personal feature data. The personal information database 105 stores (registers) the generated personal feature data. As shown in FIG. 4, a viewer number is assigned to the personal feature data. That is, the personal feature data shown in FIG. 4 and the personal information shown in FIG. 5 are managed in association with each other using the viewer number.

When the power supply of the viewing scheduling television 100 is turned on via the input module 111, or when a program is designated via the input module 111, the viewer authentication mode is executed. If authentication of the viewer has succeeded, the program designation operation or the like is accepted. When the authentication mode is executed, and the input module 116 captures an image of the viewer (face), the analysis module 106 analyzes a video captured by the input module 116 to acquire feature information of the viewer, and generates personal feature data. Furthermore, the analysis module 106 compares the generated personal feature data and the registered personal feature data read from the personal information database 105, calculates a similarity between the two data, and authenticates the viewer based on the calculation result.

Note that the case has been explained wherein the image of the viewer (face) is captured to authenticate the viewer. However, other authentication methods may be used. For example, the viewer may be authenticated using his or her fingerprints.

The analysis module 106 detects a voice level acquired by the input module 116, and the viewing schedule management module analyzes the viewing state of the user based on the detected voice level. The analysis result is reflected in the preferences and the like in the personal information. The personal information reflected with this analysis result can be used as base data of the next viewing schedule. That is, the analysis result is not reflected in the viewing schedule of the current month (without changing the viewing schedule of the current month), but it can be reflected in the viewing schedule of the next month or later.

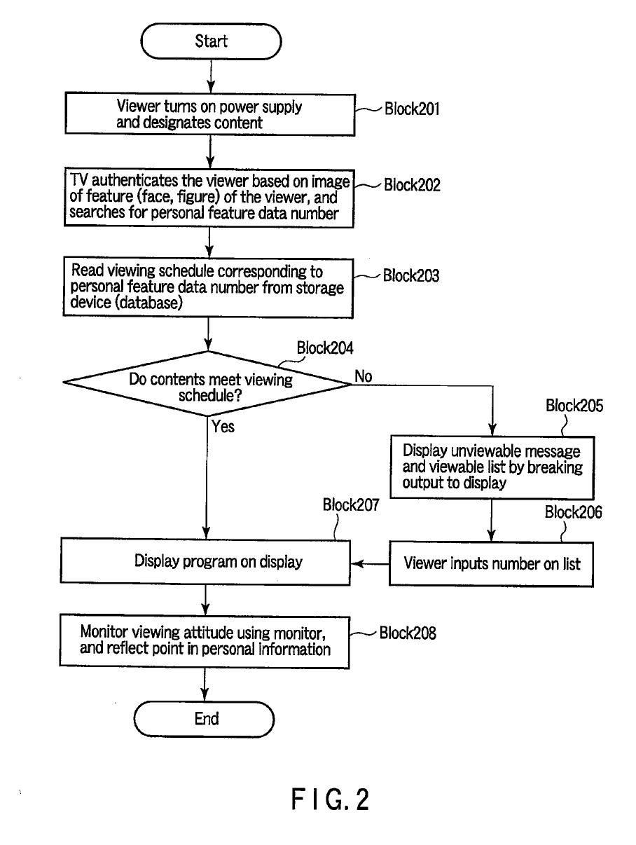

Program playback control will be described below. FIG. 2 is a flowchart showing an example of the program playback control. If the viewer turns on the power supply of the viewing scheduling television 100 via the input module 111 and designates desired content (BLOCK 201), the viewer authentication mode is executed, as described above. That is, the input module 116 captures an image of the viewer (face), and the analysis module 106 analyzes the captured video to acquire feature information of the viewer and generates personal feature data. Furthermore, the analysis module 106 compares the generated personal feature data and the registered personal feature data read from the personal information database 105, calculates similarity between the two data, and authenticates the viewer based on the calculation result (BLOCK 202).

Subsequently, when the viewer has been authenticated based on personal feature data assigned a viewer number n, the viewing schedule management module 108 reads a viewing schedule assigned the viewer number n from the viewing schedule database 114 (BLOCK 203).

Furthermore, the viewing schedule management module 108 checks if the designated content meets the conditions included in the read viewing schedule. The viewing schedule management module 108 reads (detects) the maximum viewing time of a genre of the designated content and the viewing time (the viewing record) of the genre of the designated content, and determines that the designated content meets the conditions included in the viewing schedule based on the maximum viewing time and the viewing time. The viewing schedule management module 108 permits playback of the designated content when a time difference between the maximum viewing time of the genre of the designated content and the viewing time of the genre of the designated content is a predetermined time or more (e.g., 10 minutes). For example, when the genre of the designated content is “animation”, the viewing schedule includes the maximum viewing time (8 hours) of “animation”, and the viewing record of “animation” indicates less than 8 hours (for example, the viewing record of “animation” is less than 7 hours 50 minutes), the time difference between the maximum viewing time and viewing time becomes equal to or longer than the predetermined time. In this case, the viewing schedule management module 108 determines that the designated content meets the conditions included in the read viewing schedule (YES in BLOCK 204), and permits playback of the designated content (animation). In this way, the designated content (animation) is played back, and the display 117 displays the designated content (animation) (BLOCK 207). Note that when the time difference between the maximum viewing time of a predetermined genre and the viewing record time of the predetermined genre is less than a playback time n of designated content of the predetermined genre, a guide message “you cannot view the designated content to the end” may be displayed on the display 117.

The time count module 107 counts the viewing time (playback time) of the content, and the viewing schedule management module 108 reflects the counted viewing time as the viewing record with respect to the viewing schedule. For example, when the content (animation) is played back, and the viewing time is counted, the viewing record of “animation” increases. When the viewing record of the content (animation) increases and reaches the maximum viewing time of the content (animation), playback of the content (animation) is stopped. That is, the viewer cannot view the content (animation) beyond the maximum viewing time of “animation”. In this way, the viewing control that the viewing scheduler intended can be implemented.

The camera and microphone of the input module 116 monitor a viewing attitude, which is reflected in the viewing schedule (BLOCK 208). For example, the analysis module 106 detects movement of the viewer and detects conversations of the viewer. When the movement of the viewer is large, the viewing schedule management module 108 determines that the viewer's concentration is low. When the conversation frequency of the viewer is high or the volume of the conversations of the viewer is large, the viewing schedule management module 108 also determines that the viewer's concentration is low. In both cases, the viewing schedule management module decreases the preference level.

As viewing of the content progresses, the viewing record included in the viewing schedule screen shown in FIG. 8A is updated. FIG. 8B is a view showing an example of the viewing schedule screen (a screen after the beginning of viewing). As shown in FIG. 8B, the viewing schedule screen shows the viewing time distributions depending on the genres, and also viewing records depending on the genres. For example, as can be seen from FIG. 8B, as for “animation”, the screen shows the viewing record=8 hours with respect to the viewing time distribution=8 hours, and the viewable time becomes zero.

If the viewing schedule management module 108 determines that the designated content does not meet the conditions included in the viewing schedule (NO in BLOCK 204), it inhibits playback of the designated content. That is, when the time difference between the maximum viewing time of the genre of the designated content and the viewing time period of the genre of the designated content is less than a predetermined time period (e.g., 10 minutes), the viewing schedule management module 108 determines that the content does not meet the conditions included in the viewing schedule, and inhibits playback of the designated content.

Furthermore, the viewing schedule management module 108 and display control module 113 control to display an unviewable message and a viewable list. As a result, the display 117 displays the unviewable message and viewable list. For example, when content of “animation” is designated while the viewable time of animation is zero, as shown in FIG. 8B, the display 117 displays the unviewable message and viewable list.

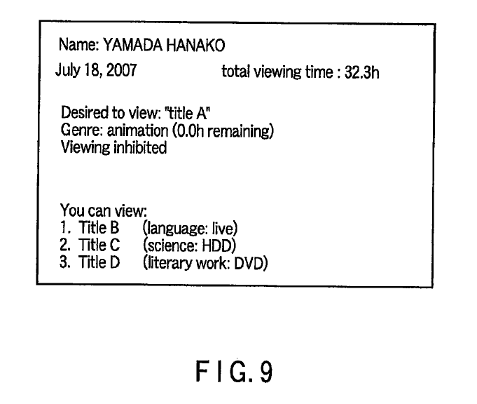

FIG. 9 is a view showing an example of a display screen of the unviewable message and viewable list. As shown in FIG. 9, the display screen of the unviewable message and viewable list displays a title (title A) and the genre (animation) of the designated content, the time difference (i.e., remaining viewing time [0 hours]) between the maximum viewing time of this genre and the viewing time of this genre, and the unviewable message. Furthermore, the display screen displays the viewable list (a list of programs that can be played back) based on the viewing schedule. For example, when viewable time of “language”, “science”, and “literature” still remain, the viewable list includes programs associated with “language”, “science”, and “literature”. Also, the display order of viewing candidates may be determined based on the maximum viewing time set for “language”, “science”, and “literature”. For example, when the maximum viewing time of “language” is 15 hours, that of “science” is 5 hours, and that of “literature” is 13 hours, the priority levels decrease in the order of “language”, “literature”, and “science”, and viewing candidates are listed on the recommended viewing list in the order of “language”, “literature”, and “science”. Alternatively, the display order of viewing candidates may be determined based on the counted viewing time of “language”, “science”, and “literature”. For example, when the counted viewing time of “language” is 10 hours, that of “science” is 4 hours, and that of “literature” is 6.5 hours, the degree of viewing attainment of “language” exceeds 60%, that of “science” is 80%, and that of “literature” is 50%. As a result, viewing candidates are listed on the recommended viewing list in the order of “literature”, “language”, and “science”. By preferentially displaying a program of a genre with a low degree of attainment, a viewing balance with respect to the viewing time distributions can be adjusted.

The viewer can designate alternate content from the display screen of the unviewable message and viewable list. Upon designation of the alternate content (BLOCK 206), the designated alternate content are played back, and the display 117 displays the designated content (BLOCK 207).

Furthermore, the viewing scheduling television 100 can implement the following.

(1) The viewing scheduling television 100 can store the schedule of the viewer (child), and can provide a recommended viewing list according to the schedule of the viewer.

(2) The viewing scheduling television 100 can export personal information and personal feature data via a USB interface and network interface.

(3) The viewing scheduling television 100 can output encrypted personal information and personal feature data to an external device.

(4) The viewing scheduling television 100 can be provided in cultural/educational facilities such as libraries, and can provide only appropriate content after viewer registration.

The viewing scheduling television 100 can obtain the following effects.

(1) The viewing scheduling television 100 can generate a recommended program list that fits a person based on the program information and personal information. As a result, the viewing scheduler is relieved of operations for checking programs suited to the viewer from a program table and the like. That is, the load on the viewing scheduler is greatly reduced.

(2) The viewing scheduling television 100 can authenticate the viewer based on the personal feature data registered in advance. As a result, the viewing scheduler need not monitor viewing by, e.g., supervising the viewer. That is, the load on the viewing scheduler is greatly reduced.

(3) The viewing scheduling television 100 can detect and tally viewing time depending on the genres. As a result, the viewing scheduling television 100 can control viewing according to the viewing records.

(4) The viewing scheduling television 100 can present a viewable list when it inhibits viewing of designated content based on the viewing schedule and viewing record. As a result, the viewing scheduling television 100 can implement viewing in a balanced manner according to the viewing schedule.

(5) The viewing scheduling television 100 can monitor the viewing attitude of the viewer, and can reflect the viewing monitoring result in the personal information. As a result, the viewing control can be attained in consideration of the viewing attitude of the viewer. That is, the viewing control that regards the viewer's preferences can be attained.

The various modules of the device described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A playback control apparatus comprising:
a setting module configured to set maximum playback time of a program depending on a genre;
a designation module configured to designate a program;
a detection module configured to detect a playback time depending on a genre of the designated program; and
a playback control module configured to control playback of the designated program based on the maximum playback time.

2. The apparatus of claim 1, wherein the playback control module is configured to control playback of the designated program based on the playback time.

3. The apparatus of claim 1, wherein when a time difference between the maximum playback time and the playback time of the genre of the designated program is less than a predetermined time, the playback control module is configured to inhibit playback of the designated program.

4. The apparatus of claim 1, wherein the setting module is configured to change the maximum playback time based on a change input of the maximum playback time.

5. The apparatus of claim 1, further comprising an output module configured to output the maximum playback time.

6. The apparatus of claim 1, wherein the output module is configured to output the playback time.

7. The apparatus of claim 1, further comprising an output module configured to output display information required to display a time difference between the maximum playback time and the playback time of the genre of the designated program.

8. The apparatus of claim 1, further comprising:
a program list generation module configured to generate a recommended program list based on genres of programs and personal information including program viewing requests depending on the genres; and
an output module configured to output the recommended program list.

9. The apparatus of claim 3, further comprising:
a program list generation module configured to detect genres which are allowed to be played back based on time differences between the maximum playback time and the playback time depending on the genres, to detect programs which are allowed to be played back based on the genres which are allowed to be played back, and to generate a list of programs which are allowed to be played back; and
an output module configured to output display information required to display the list of programs when playback of the designated program is inhibited.

10. The apparatus of claim 9, wherein the program list generation module is configured to determine a priority order of programs which are allowed to be played back based on the playback time depending on the genres, and generate the list of programs based on the priority order.

11. The apparatus of claim 1, which further comprises:
a registration module configured to register feature information of a viewer;
a reading module configured to read feature information of the viewer; and
a authentication module configured to authenticate the viewer based on the registered feature information and the read feature information, and
in which the setting module is configured to set the maximum playback time depending on the viewer,
the detection module is configured to detect the playback time depending on the authenticated viewer, and
the playback control module is configured to control playback of the designated program based on the maximum playback time set for the authenticated viewer.

12. The apparatus of claim 11, wherein the playback control module is configured to control playback of the designated program based on the playback time detected for the authenticated viewer.

13. A playback control method comprising:
setting maximum playback time of a program depending on a genre;
designating a program;
detecting a playback time depending on a genre of the designated program; and
controlling playback of the designated program based on the maximum playback time and the playback time of the genre of the designated program.

14. The method of claim 13, further comprises controlling playback of the designated program based on the playback time.
